(19) United States
(12) Patent Application Publication
(10) Pub. No.: US 2026/0228005 A1
(43) Pub. Date: Aug. 6, 2026

(54) CONTROL FLOW PREDICTION

(71) Applicant: Arm Limited, Cambridge (GB)

(72) Inventors: Rami Mohammad AL SHEIKH, Morrisville, NC (US); Krishnendra NATHELLA, Austin, TX (US); Houdhaifa BOUZGUARROU, Valbonne (FR); Michael Brian SCHINZLER, Round Rock, TX (US); Sergio SCHULER, Austin, TX (US)

(21) Appl. No.: 19/045,734

(22) Filed: Feb. 5, 2025

(51) Int. Cl. G06F 9/30; G06F 9/38

(52) U.S. Cl. CPC G06F 9/3005; G06F 9/3814; G06F 9/3842; G06F 9/3865

(57) ABSTRACT

An apparatus comprises prediction circuitry to generate a predicted outcome for each of a plurality of candidate control flow instructions and provide a confidence value associated with each predicted outcome. Reduced-latency recovery circuitry is provided to implement a reduced-latency recovery mechanism for a selected subset of candidate control flow instructions, reducing a performance impact caused by predicted outcomes of the selected subset of control flow instructions being incorrect. Selection circuitry is provided to select the selected subset of the plurality of candidate control flow instructions in dependence on the confidence values associated with the predicted outcomes for the plurality of candidate control flow instructions and at least one further attribute of the plurality of candidate control flow instructions.

### BACKGROUND

### Technical Field

The present technique relates to the field of data processing, and more particularly to prediction of control flow instructions.

### Technical Background

A data processing apparatus may execute control flow instructions (e.g., branch instructions) which determine which sequence of later instructions will subsequently be executed. Prediction of the outcome of control flow instructions can allow later instructions in a program to be speculatively fetched. This allows later instructions to be executed sooner than would be possible if the data processing system were forced to wait until the outcome of the control flow instruction was known before fetching later instructions, which can provide improved performance for the data processing system.

If the prediction of the outcome of a control flow instruction is later determined to have been incorrect, then processing of the later instructions fetched from the incorrect path may be abandoned and the data processing system may then continue processing by fetching instructions on the correct path. However, misprediction of control flow instructions can negatively impact performance, as execution may be delayed whilst waiting for instructions on the correct path to become ready for execution.

### SUMMARY

At least some examples of the present technique provide an apparatus, comprising:
prediction circuitry configured to generate a predicted outcome for each of a plurality of candidate control flow instructions and provide a confidence value associated with each predicted outcome;
reduced-latency recovery circuitry configured to implement a reduced-latency recovery mechanism for a selected subset of the plurality of candidate control flow instructions, wherein implementing the reduced-latency recovery mechanism for a given control flow instruction comprises reducing a performance impact caused by a predicted outcome of the given control flow instruction being incorrect; and
selection circuitry configured to perform a selection operation, comprising selecting the selected subset of the plurality of candidate control flow instructions, in dependence on the confidence values associated with the predicted outcomes for the plurality of candidate control flow instructions and at least one further attribute of the plurality of candidate control flow instructions.

At least some examples provide a system comprising:
the apparatus mentioned above, implemented in at least one packaged chip;
at least one system component; and
a board,
wherein the at least one packaged chip and the at least one system component are assembled on the board.

At least some examples provide a chip-containing product comprising the system mentioned above, wherein the system is assembled on a further board with at least one other product component

At least some examples provide a method, comprising:
generating a predicted outcome for each of a plurality of candidate control flow instructions;
providing a confidence value associated with each predicted outcome;
implementing a reduced-latency recovery mechanism for a selected subset of the plurality of candidate control flow instructions, wherein implementing the reduced-latency recovery mechanism for a given control flow instruction comprises reducing a performance impact caused by a predicted outcome of the given control flow instruction being incorrect; and
performing a selection operation, comprising selecting the selected subset of the plurality of candidate control flow instructions, in dependence on the confidence values associated with the predicted outcomes for the plurality of candidate control flow instructions and at least one further attribute of the plurality of candidate control flow instructions.

At least some examples provide computer-readable code for fabrication of an apparatus comprising:
prediction circuitry configured to generate a predicted outcome for each of a plurality of candidate control flow instructions and provide a confidence value associated with each predicted outcome;
reduced-latency recovery circuitry configured to implement a reduced-latency recovery mechanism for a selected subset of the plurality of candidate control flow instructions, wherein implementing the reduced-latency recovery mechanism for a given control flow instruction comprises reducing a performance impact caused by a predicted outcome of the given control flow instruction being incorrect; and
selection circuitry configured to perform a selection operation, comprising selecting the selected subset of the plurality of candidate control flow instructions, in dependence on the confidence values associated with the predicted outcomes for the plurality of candidate control flow instructions and at least one further attribute of the plurality of candidate control flow instructions.

The code may be stored on a computer-readable medium. The medium may be non-transitory.

Further aspects, features and advantages of the present technique will be apparent from the following description of examples, which is to be read in conjunction with the accompanying drawings.

### BRIEF DESCRIPTION OF THE DRAWINGS

FIG. 1 schematically illustrates an example of a data processing apparatus in accordance with one example implementation;

FIGS. 2A to 2C illustrate examples of selecting an instruction for a reduced-latency recovery mechanism from among instructions scheduled to be issued in the same cycle;

FIG. 3 is a flow diagram illustrating a method for selecting instructions for reduced-latency recovery;

FIG. 4 is a flow diagram illustrating a specific example of a method for selecting instructions for reduced-latency recovery using confidence values and at least one further attribute;

FIG. 5 schematically illustrates a data structure which may be used to form a dynamic ranking of branch instruction types;

FIG. 6 schematically illustrates a data structure which may be used to identify penalised instructions;

FIG. 7 is a illustrates an example arrangement in which a prediction for a conditional instruction is selected from among a plurality of prediction sources;

FIG. 8 is a flow diagram illustrating a specific example of selecting an instruction for a reduced-latency recovery mechanism in a system which can implement the reduced-latency recovery mechanism for a single instruction in each cycle; and

FIG. 9 illustrates a system and a chip-containing product.

### DESCRIPTION OF EXAMPLES

An apparatus comprises prediction circuitry configured to generate a predicted outcome for each of a plurality of candidate control flow instructions. The control flow instructions may include, for example, branch instructions. The predicted control flow instructions may include conditional instructions, in which case the predicted outcome may include a direction prediction indicating whether the control flow instruction is taken, causing a change in control flow, or not taken. The predicted outcome may include a predicted target of the control flow instruction, identifying a point in a program to which control flow should change.

Incorrect prediction of control flow instructions can be associated with significant performance impacts. If a control flow instruction is predicted incorrectly, then the instructions speculatively fetched into the pipeline after that control flow instruction are not the correct instructions. When it is determined that the outcome of a control flow instruction was predicted incorrectly, then the subsequent instructions may be flushed from the pipeline and instructions fetched along the correct path instead. However, it may take several processor cycles for the correct instructions to be fetched and pass through the pipeline, during which no instructions can be executed, and therefore several cycles may be wasted due to the misprediction. In modern deep pipelined processors, the penalty for misprediction of control flow instructions can be particularly high. Although modern control flow predictors often have high prediction accuracy, even a relatively small number of mispredicted instructions can have a severe impact on performance.

To reduce the impact of misprediction of control flow instructions, the apparatus provides reduced-latency recovery circuitry configured to implement a reduced-latency recovery mechanism for a selected subset of the plurality of candidate control flow instructions. Implementing the reduced-latency recovery mechanism for a given control flow instruction comprises taking steps to reduce a performance impact caused by a predicted outcome of the given control flow instruction being incorrect. For example, one or more of the misprediction recovery steps that would be taken in response to determining that the prediction was incorrect (e.g., fetching instructions along the other path for a taken/not taken prediction) may be speculatively performed before it is known whether the prediction was correct or not, and if the prediction turns out to be incorrect then, because certain misprediction recovery steps have already been performed, the performance impact of the misprediction can be reduced. The reduced-latency recovery circuitry can therefore reduce a number of wasted processor cycles associated with misprediction of a control flow instruction and hence improve performance.

Whilst the reduced-latency recovery circuitry may enable performance improvements, timing and power constraints mean that it may be difficult for the reduced-latency recovery circuitry to implement the reduced-latency recovery mechanism for every predicted control flow instruction. For example, the reduced-latency recovery circuitry may only implement the reduced-latency recovery mechanism for a limited number of instructions per cycle, and if a greater number of control flow instructions are issued in a cycle then one or more control flow instructions may not be subject to the reduced-latency recovery mechanism. Misprediction of control flow instructions for which the reduced-latency recovery mechanism is not implemented may be handled in a conventional way, and hence be associated with a significant performance penalty.

The apparatus therefore provides selection circuitry configured to perform a selection operation to select, from a plurality of candidate control flow instructions, a selected subset of control flow instructions for which the reduced-latency recovery mechanism is to be implemented. The reduced-latency recovery circuitry may provide larger performance improvements when the selected subset of control flow instructions are those which are more likely to be mispredicted, meaning that there is a greater chance of avoiding the performance penalty associated with misprediction, and therefore the selection circuitry may attempt to select the selected subset to preferentially select instructions which are more likely to be mispredicted. The selection circuitry may also preferentially select instructions which are associated with a larger misprediction penalty to seek to reduce any incurred misprediction penalty. The selection circuitry may be required to perform the selection operation before the outcomes of the plurality of candidate control flow instructions are known, such as when the instructions are issued, to allow sufficient time for the reduced-latency recovery mechanism to prepare for misprediction of a selected instruction.

The prediction circuitry is configured to provide a confidence value associated with each predicted outcome for each of the plurality of candidate control flow instructions. The confidence value for a given instruction may indicate a likelihood that the predicted outcome of the given instruction is correct, and may be based on information available to the prediction circuitry used to generate the predicted outcome. For example, the prediction circuitry may indicate whether the predicted outcome was selected from closely matched options (in which case the prediction may have a lower confidence), or whether the choice of predicted outcome was clear (in which case the prediction may have a higher confidence). The form of the confidence value is not particularly limited. In some examples, the confidence value may be a single bit indicating whether the predicted outcome is higher confidence or lower confidence. The selection circuitry is configured to select the selected subset of the plurality of candidate control flow instructions in dependence on the confidence values associated with the predicted outcomes for the candidate control flow instructions, as the confidence value may provide an accurate indication of the likelihood of misprediction of the candidate control flow instructions.

However, the inventors have realised that the confidence value alone may not provide sufficient information to select between the plurality of candidate control flow instructions. For example, two or more instructions may have similar confidence values, leaving the selection circuitry unable to make an informed choice between instructions to include in the selected subset. Therefore, the selection circuitry is configured to perform the selection operation in dependence on at least one further attribute of the plurality of candidate control flow instructions. By providing further information describing the candidate control flow instructions, the selection circuitry is able to make a more informed selection, which provide a larger reduction in misprediction penalty provided by the reduced-latency recovery mechanism, and therefore improve overall processing performance.

In some examples, the selection circuitry may be configured to select, based on the at least one further attribute, which one or more instructions to include in the selected subset from between a plurality of tied candidate control flow instructions for which the associated confidence values are the same (or are similar to within a given threshold). In some examples, a confidence value may be considered to select instructions for the reduced-latency recovery mechanism, but this may leave certain instructions tied with the same confidence value. Tied candidate control flow instructions can present a particular problem when the confidence values are provided at a coarse granularity (e.g., a two-state confidence value indicating either a lower confidence or a higher confidence), as several of the predicted outcomes of the candidate control flow instructions may be associated with the same confidence value. Without any further information, the selection circuitry may make an uninformed choice between tied instructions but, by providing at least one further attribute to the selection circuitry, the selection circuitry may select instructions more likely to be mispredicted from among the tied candidate control flow instructions.

The at least one further attribute is not particularly limited, and may be any information directly or indirectly indicative of a likelihood of misprediction for the candidate control flow instructions. An instruction which, based on the at least one further attribute, is more likely to be mispredicted may be selected for the reduced-latency recovery mechanism with preference over an instruction less likely to be mispredicted. The at least one further attribute may also or alternatively be indicative of a penalty associated with misprediction of the candidate control flow instructions, in which case an instruction with a greater misprediction penalty may be favored for the reduced-latency recovery mechanism over an instruction with a lesser misprediction penalty.

In some examples, the at least one further attribute may comprise an instruction encoding type of the plurality of candidate control flow instructions. For example, the at least one further attribute may comprise an instruction type indicated by an opcode and/or operands of a candidate control flow instruction. The inventors have identified that in many workloads the predictability of a control flow instruction is associated with the instruction type of that control flow instruction, and hence the instruction type may be considered by the selection circuitry when selecting which instructions should be covered by the reduced-latency recovery mechanism.

In some examples, the selection circuitry may be configured to perform the selection operation in dependence on a static ranking of instruction encoding types. For example, the selection circuitry may be configured to include a first type of instruction in the selected subset with preference over a second type of instruction. The inventors have realised that over many workloads certain types of instruction are more likely to be mispredicted, and hence using a static ranking of instruction types can provide an accurate and reliable way to select between candidate control flow instructions. For example, a conditional branch instruction has an outcome depending on a condition which may take various forms and hence may be difficult to predict. In contrast, a return instruction (e.g., for returning from a function) may always be taken, and may cause program flow to change to a stored address (e.g., an address which can be determined from the return stack). A return instruction may therefore be easier to predict than a conditional instruction, and may hence the selection circuitry may be configured to select a conditional instruction for inclusion in the selected subset with preference over a return instruction when using a static ranking of instruction types, increasing the likelihood of mispredictions being covered by the reduced-latency recovery mechanism.

Whilst in general a static ranking of instruction types may provide an accurate indication of predictability, there may be certain workloads where the predictability of instructions differs from the static ranking. For instance, whilst in general a branch instruction which indicates a target address as an immediate operand of the instruction (a direct branch) may be easier to predict than a branch instruction identifying a target address using a register other than a return address register (an indirect branch), there may be some workloads in which the situation is reversed. In some examples, the selection circuitry may be configured to perform the selection operation in dependence on a dynamic ranking of instruction encoding types. Using a dynamic ranking of instruction types may allow the selection based on instruction type to adapt to a current phase of a workload, which can provide a more accurate selection of an instruction most likely to be mispredicted.

The dynamic ranking of instruction types may be determined based on an observed prediction accuracy for each instruction type. For example, a plurality of counters may be provided in which each counter corresponds to a type of control flow instruction, and each counter is increased when the corresponding type of instruction is correctly predicted and decreased when the corresponding type of instruction is incorrectly predicted. The dynamic ranking of control flow instructions may be determined by ranking the values provided by the counters.

In some examples, the at least one further attribute may comprise an indication of a prediction source selected to provide the predicted outcome for each of the candidate control flow instructions. Many modern processors include a range of prediction sources providing predicted outcomes for control flow instructions. For example, processors may include static predictors (which always predict a certain outcome for a given control flow instruction), reasonably straightforward dynamic predictors such as a bimodal predictor providing a saturating counter indicating a prediction history of a branch (e.g., provided within a branch target address cache (BTAC)), and more complex dynamic predictors such as tagged-geometric (TAGE) predictors providing several predictions for an instruction tagged with increasing lengths of branch history and perceptron predictors (e.g., including a multi-perspective perceptron) in which a prediction is provided by a weighted combination of bits of an instruction address and/or branch history for a given instruction. A range of prediction sources may be provided as different predictors may provide better predictions for different types of instructions. In addition, certain prediction sources act as a fall back in case a more accurate prediction source is unable to provide a prediction for a given instruction. The prediction circuitry may select a prediction source to provide a predicted outcome for each instruction, e.g., depending on the availability of predictions and the confidence of predictions provided by each prediction source.

The inventors have recognised that the prediction source provides an accurate indication of prediction accuracy for the predicted outcomes of the plurality of candidate control flow instructions. For example, if a given instruction has a predicted outcome provided by a TAGE predictor then this may be considered more accurate than a predicted outcome for a different instruction provided by a static predictor or bimodal predictor. Therefore, an indication of a prediction source selected to provide the predicted outcome for each of the candidate control flow instructions provides a useful attribute for determining which instructions should be selected for to the reduced-latency recovery mechanism. In the example above, for two instructions which are otherwise equal but provided by different prediction sources, the prediction provided by the less accurate prediction source may be selected for the reduced-latency recovery mechanism. The ranking of prediction source accuracy may be static, or could be dynamic and hence based on an active measurement of prediction accuracy for each prediction source.

In some examples, the at least one further attribute may comprise a relative position in program order of the plurality of candidate control flow instructions. For example, an older instruction (an instruction earlier in program order) may be selected with preference over a younger instruction (an instruction later in program order). The penalty associated with incorrectly predicting an older instruction may be greater than the penalty of incorrectly predicting a younger instruction, as more instructions may be flushed from the processor when an older instruction is mispredicted, and in particular misprediction of the older instruction will result in the younger instruction being flushed. Therefore, the selection circuitry may be configured to preferentially select the older instruction for the reduced-latency recovery mechanism, as doing so may reduce the larger misprediction penalty and hence reduce the overall performance impact of misprediction.

In some examples, the at least one further attribute may comprise a memory address of a memory location associated with each of the candidate control flow instructions. For example, the selection circuitry may observe that certain individual instructions are frequently mispredicted, or are associated with a particularly high misprediction penalty, and hence may determine that those instructions should be preferentially selected for the reduced-latency recovery mechanism. As individual control flow instructions can be identified by the memory address storing the instruction (the address that will be indicated by the program counter (PC) register when the program reaches that instruction), the memory address may therefore be provided to the selection circuitry as a further attribute for performing the selection operation.

In some examples, the selection circuitry may be configured to maintain a data structure identifying one or more penalised memory addresses, and perform the selection operation in dependence on whether each of the plurality of candidate control flow instructions is associated with a penalised memory address. For example, an instruction associated with a penalised memory address may be preferentially selected for the reduced-latency recovery mechanism. The data structure may also provide a prediction accuracy mechanism. For example, entries in the data structure may correspond to an instruction and provide an accuracy field indicating an accuracy of recent predictions made for that instruction. If an accuracy value in the accuracy field falls below a threshold, then that may identify the corresponding instruction as a penalised instruction. By measuring the accuracy associated with control flow instructions, the selection circuitry may be configured to make a more informed selection between candidate control flow instructions, and in particular the selection may vary throughout different phases of a workload as accuracy values are updated, and therefore the selection may dynamically respond to provide a more accurate prediction.

In some examples, a single further attribute may be considered by the selection circuitry. In other examples, two or more further attributes may be considered in combination by the selection circuitry. It is not particularly limited how the selection circuitry ranks the different further attributes, and it may depend on implementation which of two or more instructions to select for the selected subset when two or more of the further attributes for those instructions differ. In some examples, the further attributes may be considered in order (e.g., a first attribute is considered first, then only if that attribute does not distinguish the instructions, a second attribute may be considered), or the selection circuitry may apply a ranking taking into account several further attributes at once (e.g., a conditional instruction predicted using a static predictor may be selected with preference over a conditional instruction predicted using a TAGE predictor, which may be selected with preference over a return instruction).

The plurality of candidate control flow instructions may be selected in various ways. In some examples, the plurality of candidate control flow instructions may comprise control flow instructions selected to be issued in a given processing cycle. If the plurality of candidate control flow instructions includes more instructions than a number of instructions which can be selected for the reduced-latency recovery mechanism in a given cycle, then it is not possible for all of the candidate control flow instructions to be issued in the same cycle and selected for the reduced-latency recovery mechanism. Hence, the selection circuitry may select the subset of the candidate control flow instructions for the reduced-latency recovery mechanism.

As mentioned above, in some examples the prediction circuitry may be configured to provide a confidence value having one of two states representing: a lower confidence predicted outcome and a higher confidence predicted outcome. With such a confidence value, it may be common that several instructions have the same confidence value, and hence in such examples the further attribute may be particularly useful for selecting between candidate control flow instructions. The inventors have identified that, when confidence alone is used to select instructions for fast recovery, a majority of penalised mispredictions can be attributed to cases where there is more than one higher confidence branch issued per cycle, and therefore use of the at least one further attribute for selecting between such instructions may result in a significant performance advantage.

In some examples where the confidence value has one of two states, the selection circuitry may be configured to always select an instruction having the lower confidence predicted outcome to be in the selected subset selected for the reduced-latency recovery mechanism. The at least one further attribute may therefore be used to select between tied candidate control flow instructions having the higher confidence predicted outcome, for example when the reduced-latency recovery circuitry has available capacity above the capacity required to implement the reduced-latency recovery mechanism for all of the control flow instructions with lower confidence predicted outcomes. Whilst instructions having the higher confidence may be less likely to be mispredicted than the lower confidence instructions, they may still have a risk of misprediction and overall performance may be improved if the instructions most likely to be mispredicted are selected for reduced-latency recovery.

In some examples, the apparatus comprises issuing circuitry responsive to a determination that the selected subset of candidate control flow instructions comprises a threshold number of control flow instructions to issue at least two of the selected subset of candidate control flow instructions in different processing cycles. The reduced-latency recovery circuitry may support implementing the reduced-latency recovery mechanism for the threshold number of instructions per cycle. The selection circuitry may seek to reduce a number of instructions selected for the reduced-latency recovery mechanism, but in some cases the selected subset may exceed the threshold number of instructions. In some examples the plurality of candidate control flow instructions may nevertheless be issued in a single cycle with the reduced-latency recovery mechanism applied to a threshold number of instructions of the selected subset. However, in other examples the issuing circuitry may be configured to delay issuing at least one of the candidate control flow instructions until a later cycle (e.g., a cycle having fewer instructions selected for the reduced-latency recovery mechanism), thereby allowing the reduced-latency recovery mechanism to be implemented for the delayed candidate control flow instruction(s).

Although it may appear counter-intuitive to seek to improve performance by delaying issuing certain instructions, the inventors have realised that the penalty associated with delaying an instruction to a later cycle (e.g., incurring a one cycle penalty) may be smaller than the penalty associated with issuing the instruction without the reduced-latency recovery mechanism and the instruction mispredicting (which may cause a delay of several cycles). Overall performance may not be improved however by delaying every instruction until it can be covered by the reduced-latency recovery mechanism, and hence the selection circuitry is required to filter the candidate control flow instructions to provide a selected subset for the reduced-latency recovery mechanism, with only instructions in the selected subset being delayed if required.

The reduced-latency recovery mechanism is not particularly limited. In some examples, implementing the reduced-latency recovery mechanism for the given control flow instruction may comprise speculatively performing at least one recovery operation which would be performed if the predicted outcome of the given control flow instruction were determined to be incorrect. For example, if a taken/not taken prediction is determined to be incorrect, instructions on the non-predicted path are fetched and passed down the pipeline, and therefore the reduced-latency recovery mechanism may comprise fetching and performing certain pre-execution operations (e.g., decoding) on instructions down the opposite path to the predicted outcome of an instruction. For example, if a conditional instruction is predicted to be taken, then instructions along the non-taken path may be fetched as part of the reduced-latency recovery mechanism to be ready in case the prediction is incorrect (and the correct outcome of the instruction is non-taken).

In some examples, the processing circuitry is configured to trigger a pipeline flush in response to a determination that a predicted outcome of a target control flow instruction, for which the reduced-latency recovery mechanism is not implemented, is incorrect. Triggering a pipeline flush may be associated with a severe performance penalty, and therefore it is desirable for the selection circuitry to select instructions for which the reduced-latency recovery mechanism is to be implemented to be the instructions most likely to be predicted incorrectly.

In some examples, the at least one further attribute may comprise an indication of whether each of the plurality of candidate control flow instructions has been classified by the prediction circuitry as a hard-to-predict control flow instruction. Certain control flow instructions may be particularly difficult to predict. For example, they may be data-dependent branch instructions for which the outcome depends on data loaded from memory and which are therefore uncorrelated with a branch history. The prediction circuitry may provide circuitry for identifying hard-to-predict control flow instructions, and may therefore provide an indication of whether each of the plurality of candidate control flow instructions has been classified by the prediction circuitry as a hard-to-predict control flow instruction to the selection circuitry. The selection circuitry may be configured to preferentially select a hard-to-predict control flow instruction for the selected subset compared to an instruction not indicated to be a hard-to-predict control flow instruction.

Particular examples will now be described with reference to the figures.

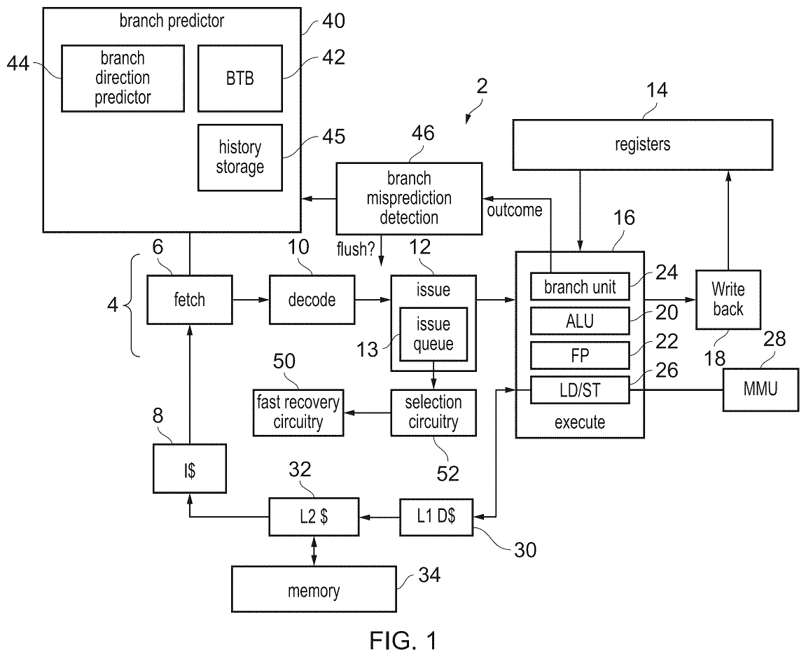

FIG. 1 schematically illustrates an example of a data processing apparatus 2 in accordance with one example implementation. The data processing apparatus has a processing pipeline 4 which includes a number of pipeline stages. In this example, the pipeline stages include a fetch stage 6 for fetching instructions from an instruction cache 8; a decode stage 10 for decoding the fetched program instructions to generate decoded instructions to be processed by remaining stages of the pipeline; an issue stage 12 for queueing instructions in an issue queue 13 and checking whether operands required for the instructions are available in a register file 14 and issuing instructions for execution once the required operands for a given micro-operation are determined to be available; an execute stage 16 for executing data processing operations corresponding to the instructions, by processing operands read from the register file 14 to generate result values; and a writeback stage 18 for writing the results of the processing back to the register file 14. It will be appreciated that this is merely one example of a possible pipeline architecture, and other systems may have additional stages or a different configuration of stages. For example, in an out-of-order processor a register renaming stage could be included, e.g. between the decode stage 10 and issue stage 12, for mapping architectural registers specified by program instructions or instructions to physical register specifiers identifying physical registers in the register file 14. Also, for an out-of-order processor, the writeback stage 18 may use a reorder buffer to track completion of instructions executed out-of-order.

The execute stage 16 includes a number of processing units, for executing different classes of processing operation. For example the execution units may include a scalar arithmetic/logic unit (ALU) 20 for performing arithmetic or logical operations on scalar operands read from the registers 14; a floating point unit 22 for performing operations on floating-point values; a branch unit 24 for evaluating the outcome of branch operations and adjusting the program counter which represents the current point of execution accordingly; and a load/store unit 26 for performing load/store operations to access data in a memory system 8, 30, 32, 34. A memory management unit (MMU) 28 may be provided to perform memory management operations such as address translation and checking of memory access permissions. The address translation mappings and access permissions may be defined in page table structures stored in the memory system. Information from the page table structures can be cached in a translation lookaside buffer (TLB) provided in the MMU 28.

In this example, the memory system includes a level one data cache 30, the level one instruction cache 8, a shared level two cache 32 and main system memory 34. It will be appreciated that this is just one example of a possible memory hierarchy and other arrangements of caches can be provided. The specific types of processing unit 20 to 26 shown in the execute stage 16 are just one example, and other implementations may have a different set of processing units or could include multiple instances of the same type of processing unit so that multiple instructions of the same type can be handled in parallel. It will be appreciated that FIG. 1 is merely a simplified representation of some components of a possible processor pipeline architecture, and the processor may include many other elements not illustrated for conciseness. The execute stage 16 (or alternatively, the pipeline 4 as a whole) can be regarded as an example of processing circuitry for performing processing operations.

As shown in FIG. 1, the apparatus 2 includes a branch predictor 40 for predicting outcomes of branch instructions (which are examples of control flow instructions). The branch predictor is looked up based on addresses of instructions to be fetched by the fetch stage 6 and provides a prediction of whether those instructions are predicted to include branch instructions, e.g. instructions capable of causing a non-sequential change in program flow (a change of program flow other than a sequential transition from one instruction address to the immediately following instruction address in a memory address space). For any predicted branch instructions, the branch predictor 40 provides a prediction of their branch properties such as a branch type, branch target address and branch direction (the branch direction indicating whether the branch is predicted to be taken or not taken). The branch predictor 40 includes a branch target buffer (BTB) 42 for predicting properties of the branches other than branch direction, a branch direction predictor (BDP) 44 for predicting the not taken/taken outcome (branch direction), and history storage circuitry 45 which stores history information indicative of the program flow history.

It will be appreciated that the branch predictor could also include other prediction structures not shown in FIG. 1, such as a history-dependent target address predictor for predicting branch target addresses for harder-to-predict branches (often referred to as polymorphic branches) whose target address depends on program flow history of instructions prior to the branch, a call-return stack for predicting return addresses of function calls, a loop direction predictor for predicting when a loop controlling instruction will terminate a loop, or other more specialised types of branch prediction structures for predicting behaviour of outcomes in specific scenarios.

Branch misprediction detection circuitry 46 detects, based on outcomes of branch instructions executed by the branch unit 24 of the processing circuitry 4, 16, whether a branch has been incorrectly predicted, and controls the pipeline 4 to suppress effects of the incorrectly predicted branch instruction and cause execution of instructions to resume based on the correct branch outcome (e.g. by flushing operations that are younger than the branch in program order and resuming fetching from the instruction that should be executed after the branch). The prediction state data in the BTB 42 and branch direction predictor 44 is trained based on the outcomes of executed branch instructions detected by branch misprediction detection circuitry 46. While FIG. 1 shows the branch misprediction detection circuitry 46 as separate from the branch unit 24, execute stage 16 and branch predictor 40, in other examples the branch misprediction detection circuitry 46 could be regarded as part of the processing circuitry 4, 16 or part of the branch prediction circuitry 40.

As shown in FIG. 1, the apparatus 2 also comprises reduced-latency recovery circuitry 50 (also termed fast recovery circuitry). The fast recovery circuitry 50 reduces a number of cycles taken to recover from misprediction of a selected branch instruction. For example, the fast recovery circuitry 50 may speculatively fetch and decode instructions on a path opposite to the predicted path of a particular branch instruction in case the branch is determined to have been mispredicted, and if branch misprediction is detected then the instructions on the opposite path can be passed to the execute unit 16 to continue processing without having to wait for the correct instructions to be fetched and propagate down the processor pipeline. If an instruction selected for fast recovery is determined to have been predicted correctly, then any speculative steps taken by the fast recovery circuitry to be prepared in the event of misprediction of that instruction may be discarded and processing may continue without the fast recovery circuitry taking any action.

The issue circuitry 12 may issue several branch instructions for execution in a given processor cycle. Whilst in some examples the fast recovery circuitry 50 could be made large enough to provide fast recovery for every instruction issued in a given cycle, power and timing constraints mean that the fast recovery circuitry 50 may be limited to providing fast recovery for a threshold number of instructions (in some examples, a single instruction) each cycle. Therefore, in some cycles there may be some instructions for which fast recovery is not implemented. If an instruction is not selected for fast recovery and is determined to have been mispredicted, then the misprediction may be handled by flushing the pipeline and fetching instructions along a correct execution path, incurring a performance penalty. Overall performance is improved when the instructions for which fast recovery is implemented are the instructions most likely to be mispredicted and/or the instructions with a highest misprediction penalty, as on average selecting these instructions will reduce a performance penalty caused by misprediction more than selecting instructions which are less likely to be mispredicted and/or have a smaller misprediction penalty. Therefore, selection circuitry 52 is provided to select, out of the instructions scheduled to be issued in a given cycle, a number of instructions for fast recovery. The selection circuitry 52 may be configured to make a selection between instructions at the issue stage of the pipeline, downstream of the prediction circuitry. It may be required to select instructions for fast recovery before those instructions are executed, so that the fast recovery circuitry has time to prepare for any eventual misprediction in advance of the instructions being executed and a misprediction being detected.

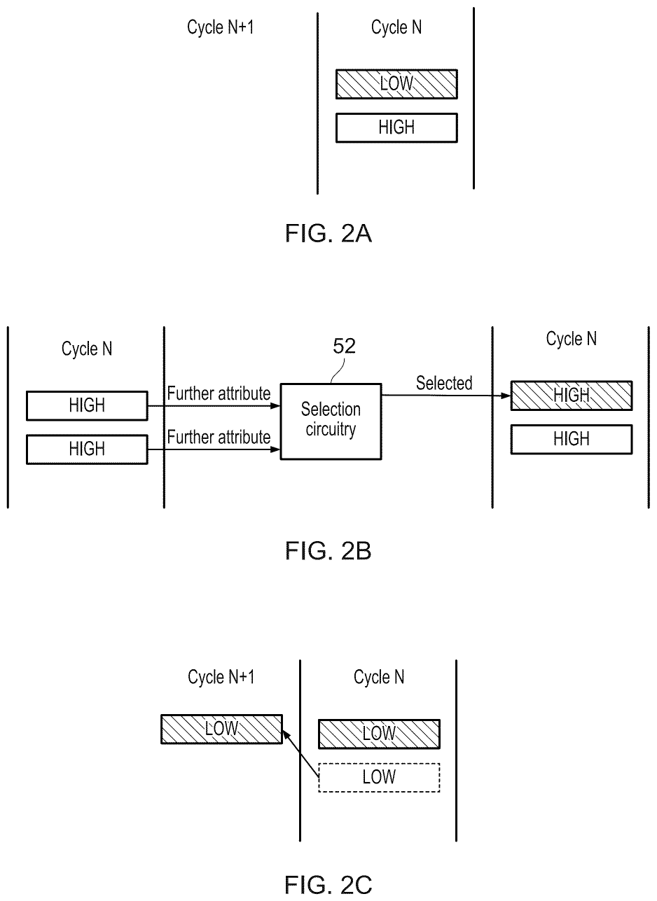

The branch predictor 40 is configured to provide a confidence value to the selection circuitry 52 indicating a level of confidence that the predicted outcome for a given branch instruction is correct. In some examples the confidence value is a single bit identifying for each branch instruction whether the prediction is (relatively speaking) either high confidence or low confidence. The confidence indication is used to select instructions for fast recovery. For example, a branch for which the prediction has been categorised as low confidence by the branch predictor 40 may always be selected for fast recovery. FIG. 2A illustrates this situation in an example where two branch instructions are issued in cycle N and the fast recovery circuitry can implement fast recovery for one instruction. When one of the instructions is high confidence and the other is low confidence, the low confidence instruction may be selected for fast recovery (indicated by the shaded box in FIG. 2A).

However, the selection circuitry 52 encounters a problem when the number of low confidence branches to be issued in a cycle is less than a number of instructions which can be selected for fast recovery (e.g., if there are no low confidence branches), and therefore when one or more of the instructions having a higher confidence prediction can be selected for fast recovery. In this case, it would be preferable to choose, from among the high confidence instructions, instructions for fast recovery which have the greatest chance of misprediction and/or the greatest misprediction penalty. However, the selection circuitry might have no further information with which to distinguish the instructions and hence may only be able to select the instructions at random. According to the present techniques, the selection circuitry 52 is therefore provided with at least one further attribute classifying the instructions to be issued in a given cycle, allowing the selection circuitry 52 to implement a tie-break to select, from otherwise indistinguishable instructions, which instructions would be a better choice for fast recovery.

FIG. 2B for example illustrates an example in which two high confidence branch instructions are scheduled to be issued in cycle N. The selection circuitry 52 is configured to consider at least one further attribute of the instructions to select one of the instructions for fast recovery. In this example, the other high confidence branch is issued without being selected for fast recovery, and hence misprediction of the other high confidence branch will incur a performance penalty. Therefore, the instruction most likely to be mispredicted, or associated with the larger performance penalty, as indicated by the at least one further attribute is selected for fast recovery.

In some examples, the selection circuitry 52 may be unable to select between instructions. For example, a number of low confidence branches issued in a single cycle may exceed a number of instructions supported by the fast recovery circuitry but it may be desired for all low confidence instructions to be selected for fast recovery. Similarly, instructions (either low or high confidence) may be indistinguishable even when considering at least one further attribute. In some cases, overall performance may be improved by delaying at least one of the instructions from being issued until a later cycle. FIG. 2C illustrates this situation in an example where two low confidence branch instructions are issued in cycle N where fast recovery circuitry supports fast recovery for one instruction per cycle, and rather than selecting one of the two instructions for fast recovery, both instructions are selected for fast recovery and one of the instructions is delayed to a subsequent processing cycle. In this example, the selected subset includes all of the candidate control flow instructions, and therefore it will be seen that the selection circuitry is not required to select a proper subset of the candidate control flow instructions. Delaying issue of a branch instruction incurs a penalty, but the penalty for delaying an instruction may be smaller than the penalty associated with misprediction of the branch instruction. If the probability of misprediction is high enough, then it may be justified to incur the predictable penalty of delaying issuing the branch instruction than risking the high penalty of misprediction. Therefore, in some examples, the selection circuitry 52 may select from a plurality of instructions to be issued in a single cycle more instructions for fast recovery than can be selected for fast recovery in a single cycle, and the difference may be accounted for by delaying issuing of some instructions.

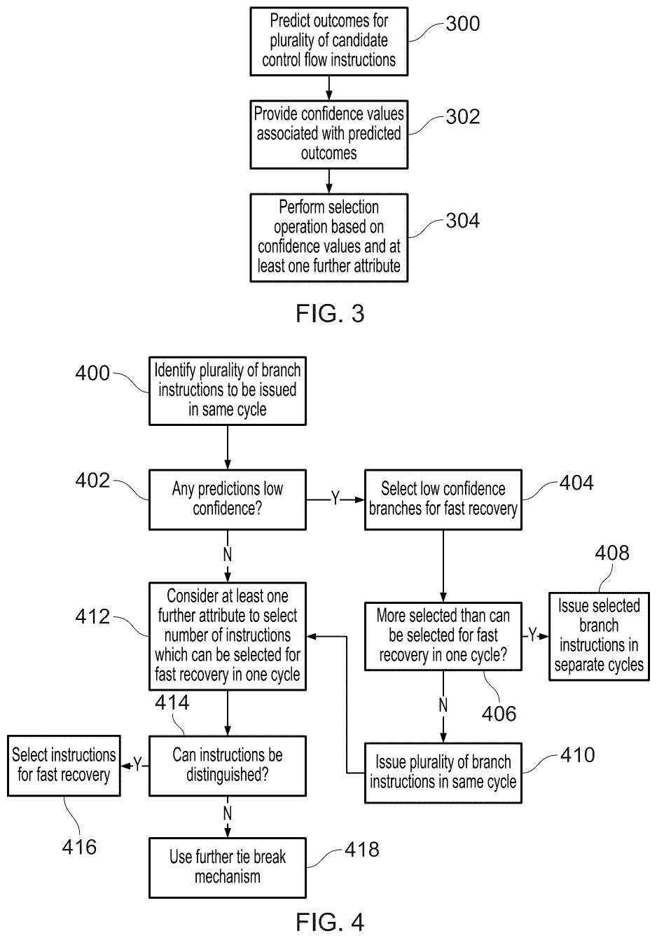

FIG. 3 is a flow diagram illustrating a method for selecting instructions for reduced-latency recovery. At step 300, prediction circuitry 40 predicts branch outcomes for a plurality of candidate control flow instructions, controlling the fetch circuitry 6 to fetch further instructions along the predicted paths. At step 302, the prediction circuitry 40 provides confidence values associated with the predicted outcomes of the plurality of candidate control flow instructions to selection circuitry 52. At step 304, the selection circuitry 52 selects a selected subset of the candidate control flow instructions, for the reduced-latency recovery circuitry 50 to implement a reduced-latency recovery mechanism, in dependence on the confidence values provided by the prediction circuitry 40 and at least one further attribute of the candidate control flow instructions.

FIG. 4 is a flow diagram illustrating a specific example of a method for selecting instructions for reduced-latency recovery using confidence values and at least one further attribute. In the example of FIG. 4, the at least one further attribute is used as a tie-break mechanism for instructions having the same confidence value.

At step 400, the selection circuitry 52 identifies a plurality of candidate control flow instructions scheduled to be issued in the same processing cycle.

At step 402, it is determined whether any of the candidate control flow instructions have a predicted outcome which has been associated with a low confidence indication by the prediction circuitry 40. If so, then the control flow instructions associated with a low confidence prediction are selected by the selection circuitry 52 for fast recovery at step 404. At step 406, it is determined whether the number of selected instructions exceeds a total number of instructions supported by the fast recovery circuitry 50 to be selected for fast recovery in a single cycle. If so, then at step 408 at least one instruction is delayed to a later cycle.

Therefore, a maximum number of instructions for which fast recovery is supported are issued in a first cycle with the fast recovery mechanism implemented, along with any high confidence branches from the candidate control flow instructions. The fast recovery circuitry 50 for example performs various speculative operations to prepare in case of misprediction of those instructions. The remaining instructions selected for fast recovery are delayed to a subsequent cycle, at which point they are also issued with the fast recovery mechanism.

If, however, a total number of low confidence instructions does not exceed a number of instructions for which fast recovery can be implemented, then at step 410 all of the low confidence branches in the candidate control flow instructions (and any high confidence branches) are issued in the same cycle.

If there were no low confidence branch instructions in the candidate control flow instructions, or if the number of low confidence branches is less than a number of instructions which can be selected for fast recovery in the same cycle, then at step 412 at least one of the high confidence branches is selected for fast recovery (such that the total number of instructions selected for fast recovery equals the maximum number which can be supported by the fast recovery circuitry 50 in a single cycle). The selection circuitry 52 considers at least one further attribute of the candidate control flow instructions to distinguish between the high confidence branch instructions, examples of which will be discussed below.

At step 414 the selection circuitry 52 determines whether it is able to distinguish between the high confidence branch instructions to select one or more instructions for fast recovery. If so, then at step 416 the selection circuitry 52 selects the one or more instructions such that the fast recovery mechanism is implemented for those instructions when they are executed. However, several instructions may be indistinguishable even when considering at least one further attribute. If this is the case, then all of the instructions could be selected for fast recovery (and one or more instructions delayed to a later cycle) or, as the risk of misprediction may not be high enough to justify delaying the instructions, a further tie break mechanism may be used to select between indistinguishable high confidence branch instructions at step 418. For example, the further tie break mechanism may include making a random selection between the high confidence branch instructions which are identified by the further attribute as being the most likely branch instructions to be mispredicted.

As discussed earlier, the at least one further attribute is not particularly limited.

In some examples, the at least one further attribute includes a type of instruction of the candidate control flow instructions, e.g., identified by the instruction encoding.

For example, the selection circuitry may rank branch instructions according to a static ranking of likelihood of misprediction. In one example, among high confidence branch instructions, the selection circuitry 52 may select conditional branch instructions for fast recovery with a highest priority. Conditional branch instructions are those for which the outcome (whether the branch is taken or not taken) depends on a condition (e.g., the state of condition flags at the time of instruction execution), which may be harder to predict due to the unpredictability of condition outcomes (especially when the condition depends on data). Indirect branch instructions specify a target address using a register, compared to direct branch instructions which directly specify in the instruction encoding a target address as an offset from the current program counter address. As the data in the target address register is subject to change, the target of indirect branch instructions can be difficult to predict. However, non-conditional indirect branch instructions may be predicted on average more successfully than conditional branch instructions and hence conditional branch instructions may be selected for fast recovery with preference over (non-conditional) indirect branch instructions. A specific type of indirect branch instruction is a return branch instruction, used for returning from functions. When branching to function code, a return address may be saved in a link register, and a return branch instruction may cause program flow to change to the address indicated in the link register. A return branch instruction might be identified by its opcode, or identified due to being a branch instruction specifying the link register as a source operand. A return branch instruction may be more straightforward to predict than a general indirect branch instruction, as the target address for a return branch instruction may be obtained from a return stack tracking which addresses have been stored in the link register. Therefore, the selection circuitry 52 may select a general indirect branch instruction for fast recovery with preference over a return instruction. Any other branch instructions may be selected with lower preference than the aforementioned branch instructions. Hence, an example static ranking of instruction types is (from order of higher preference for selection for fast recovery): conditional>indirect>return>all else.

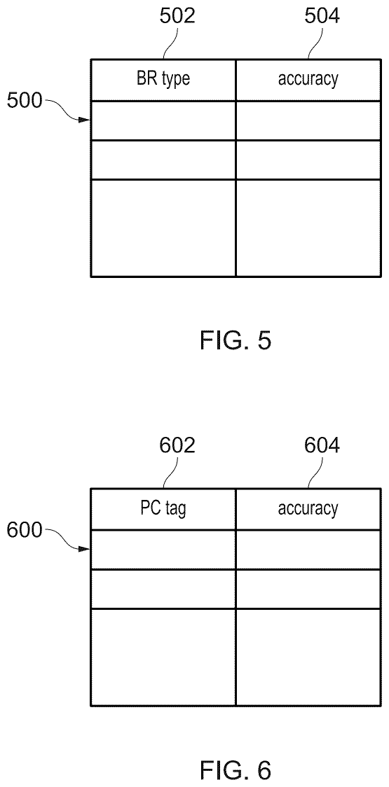

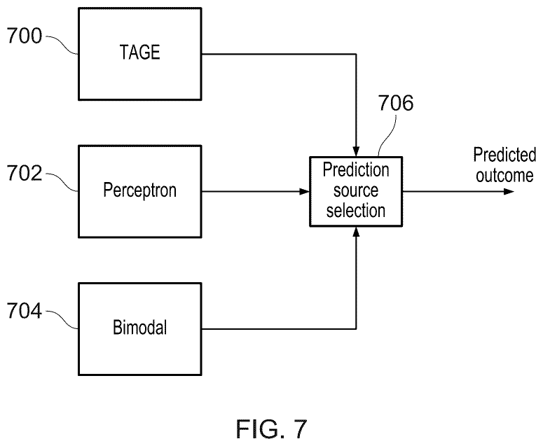

However, in some phases of a workload, the predictability of branch instructions may differ from the static ranking mentioned above. Therefore, in some examples, a dynamic ranking of instruction types may be used to select instructions for fast recovery. FIG. 5 schematically illustrates a data structure which may be used to form a dynamic ranking of branch instruction types. Such a data structure may for example be maintained by the selection circuitry 52. As illustrated in FIG. 5, a plurality of entries 500 may be provided. Each entry is associated with a type of branch instruction (e.g., conditional instructions, indirect instructions, return instructions), and provides an accuracy field 504 storing an accuracy value. The accuracy value may be incremented in response to observing correct predictions for the corresponding type of branch instruction, and decremented in response to observing incorrect predictions for the corresponding type of branch instruction. The accuracy value is therefore indicative of the likelihood of misprediction for each type of branch instruction and can hence be used to form a ranking indicating an order for selecting branch instructions for fast recovery.

In addition to, or instead of, selecting instructions based on a likelihood of misprediction of the type of branch instruction, the selection circuitry 52 may identify certain individual branch instructions (at particular locations in a program) having a high likelihood of misprediction, and may preferentially select those instructions for the fast recovery mechanism. This can be useful as even within a certain type of instruction, different instructions (stored at different memory addresses) may have different rates of misprediction. For example, a first conditional branch instruction may have a data-dependent condition (e.g., whether or not the condition is satisfied may depend on a data value in memory) whereas a second conditional branch may have a condition which is not data dependent (and may always be the same at a given point in a program). In this example, the first conditional branch instruction may be significantly harder to predict and may hence represent a better choice for fast recovery than the second conditional branch instruction. Therefore, the selection circuitry 52 may identify, at the granularity of an instruction, certain instructions to be preferentially selected for fast recovery. FIG. 6 schematically illustrates a data structure which may be used to identify instructions for preferential selection for fast recovery. Such a data structure may for example be maintained by the selection circuitry 52. As illustrated in FIG. 6, a plurality of entries 600 may be provided. Each entry is associated with particular branch instruction, which may be identified by a tag value calculated using the memory address of the corresponding instruction. Each entry provides an accuracy field 604 storing an accuracy value. The accuracy value may be incremented in response to observing correct predictions for the corresponding branch instruction, and decremented in response to observing incorrect predictions for the corresponding branch instruction. The accuracy value is therefore indicative of the likelihood of misprediction for the specific branch instruction. The accuracy values could either be used to rank candidate branch instructions due to be issued in a given cycle, or could be used to identify a number of penalised instructions having an accuracy below a threshold level, and if any of the candidate branch instruction are penalised instructions then those instructions may be preferentially selected for fast recovery.

In some examples, the prediction circuitry 40 may generate a predicted outcome for an instruction based on one of a plurality of prediction sources. For example, a number of mechanisms can be used to determine whether a conditional branch instruction is predicted to be taken or not taken. FIG. 7 illustrates an example arrangement in which a prediction for a conditional instruction is selected by prediction source selection circuitry 706 from among a TAGE predictor 700, perceptron predictor 702, and bimodal predictor 704.

The bimodal predictor 704 may provide, for each branch instruction, a saturating counter indicating whether the branch should be predicted to be taken or not taken. The counter may be one bit or multi-bit, e.g., a two-bit counter may have a strong not-taken state, a weak not-taken state, a weak taken state, and a strong taken state. The counter may be incremented or decremented based on previously observed outcomes of that branch instruction, and hence may provide an accurate prediction for branch instructions which repeatedly have the same outcome (but less accurate predictions for branch instructions which have varying outcomes).

The TAGE predictor 700 may provide more accurate predictions for branch instructions which have different outcomes at different points in a program. The TAGE predictor 700 may use a branch history (i.e., a record of whether previously executed branch instructions were taken or not taken, which may be global (i.e., a branch history of all branch instructions) or local (specific to the predicted branch instruction)) to associate the particular branch instruction within a particular point in a program, and provide a predicted branch outcome (e.g., using an N-bit saturating counter) based on previously observed outcomes of the branch instruction at that point in the program (i.e., for the particular combination of the branch instruction and the branch history). For a TAGE predictor 700 specifically, a range of predictions may be provided for different lengths of branch history across a range of TAGE tables. When a lookup hits in any of the TAGE tables, a prediction may be generated from the entry looked up using the longest length of branch history information. That is, a TAGE predictor may preferentially select a value prediction based on an entry hit in a table indexed based on a longer history information, but if no hit is identified in the longer history tables then a prediction from a table indexed based on a shorter length of history can be used instead. This approach can provide high performance because TAGE predictors can remove the need to compromise between shorter history (which is more likely to hit against an entry but for which the prediction is less accurate) and longer history (which is less likely to hit against an entry but if it does then the prediction is more accurate) as both short and long history can be used to look up different tables. A TAGE predictor 700 may therefore provide particularly high accuracy branch predictions.

The perceptron predictor 702 may store sets of weights, and a prediction may be generated based on a sum of terms, each term depending on a respective weight selected based on a respective portion of the program counter and/or history information.

It will be appreciated that many prediction mechanisms are available, and the prediction sources shown in FIG. 7 are merely an example for illustrating the present techniques.

As mentioned above, the prediction sources may have a range of prediction accuracies. For example, a bimodal predictor may generally have a lower prediction accuracy than the TAGE predictor, and may be provided as a fall-back mechanism in case the TAGE predictor does not contain any entries corresponding to a current branch history. The prediction source used to generate a particular prediction may therefore be provided to the selection circuitry 52 as a further attribute indicating the likelihood of misprediction for each candidate branch instruction, and the selection circuitry 52 may select instructions for the fast recovery mechanism depending on the prediction source used to generate the prediction.

For example, the selection circuitry 52 may be configured to distinguish between conditional branch instructions based on the prediction source used to predict each instruction, favouring instructions for selection when they have an outcome predicted by a less accurate prediction source. The relative accuracies of prediction sources may be ranked statically, or using a dynamic scheme similar to that illustrated in FIG. 5.

A further attribute which may be considered by the selection circuitry 52 is the relative age of the candidate branch instructions. The relative age of instructions may for example be determined based on the order the instructions were fetched into the pipeline. The relative age of branch instructions may not indicate their likelihood of misprediction, but may indicate a penalty associated with misprediction. For example, if an older instruction is mispredicted then a larger number of instructions may be flushed from the pipeline than if a younger instruction is mispredicted (and hence the misprediction penalty may be larger for the older instruction). If two or more branch instructions are otherwise indistinguishable, the age may provide an effective mechanism for selecting between those instructions to select instructions for fast recovery.

Whilst the discussion above presents the at least one further attribute as a mechanism for tie-breaking between instructions having the same confidence indication, it will be appreciated that the at least one further attribute may be combined with the confidence indication in different ways (e.g., the confidence value could be used to tie-break between instructions having the same value of the at least one further attribute). In certain examples, the at least one further attribute may be considered independently from a confidence indication provided by prediction circuitry 40. For example, in certain examples any combination of the at least one further attribute may be used to select between instructions for fast recovery, without a confidence indication being considered by the selection circuitry 52. As discussed above, the at least one further attribute may provide an accurate indication of a likelihood of misprediction of the candidate control flow instructions, and therefore in some examples may be considered when selecting instructions for the reduced-latency recovery mechanism without also considering a confidence value provided by the prediction circuitry 40.

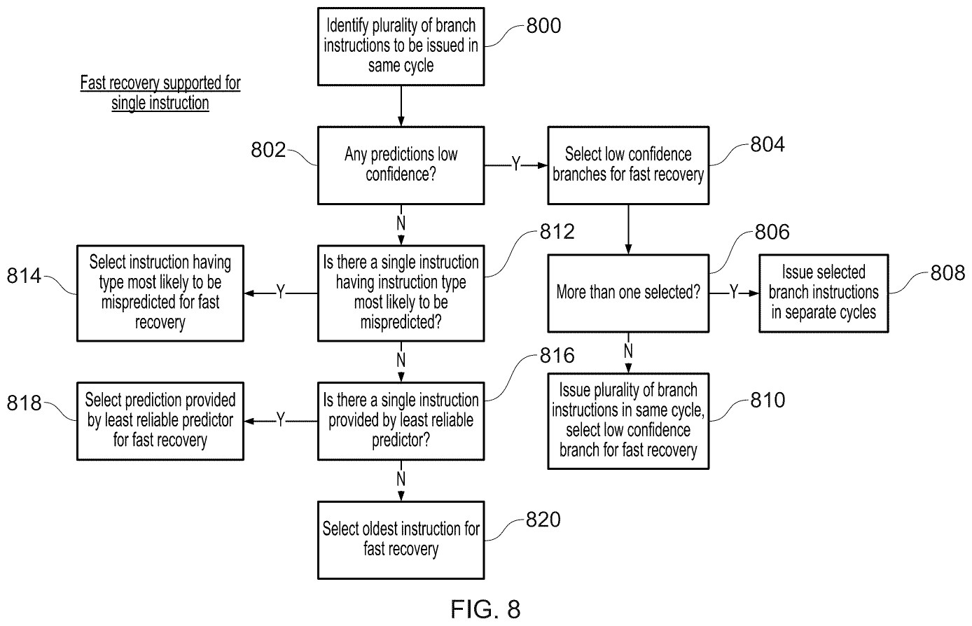

FIG. 8 is a flow diagram illustrating a specific example of selecting an instruction for fast recovery in a system having fast recovery circuitry 50 which can implement the fast recovery mechanism for a single instruction in each cycle.

At step 800, the selection circuitry 52 identifies a plurality of candidate branch instructions scheduled to be issued in the same processing cycle.

At step 802, it is determined whether any of the candidate branch instructions have a predicted outcome which has been associated with a low confidence indication by the prediction circuitry 40. If so, then the branch instructions associated with a low confidence prediction are selected by the selection circuitry 52 for fast recovery at step 804. At step 806, it is determined whether more than one instruction was selected for fast recovery. If so, then at step 808 at least one instruction is delayed to a later cycle, such that only a single instruction selected for fast recovery is issued per cycle.

If there is not more than one low confidence branch, then at step 810 the plurality of branch instructions identified in step 800 may be issued in the same cycle, with the single low confidence branch selected for fast recovery.

If at step 802 it was determined that there were no low confidence branches, then the selection circuitry selects an instruction for fast recovery from between the high confidence branches.

At step 812, the selection circuitry determines whether there is a single instruction among the selected branch instructions which has an instruction type (indicated by the instruction encoding) most likely to be mispredicted. For example, the selection circuitry determines whether there is a single conditional branch among the selected branch instructions. If there is a single branch identified at step 812, then at step 814 that branch instruction is selected from fast recovery.

However, if there are two or more branch instructions having the branch type most likely to be mispredicted, then the process continues to step 816. At step 816 it is determined whether the instruction identified in step 812 include a single instruction provided by a less reliable prediction source (e.g., if there is one prediction provided by a bimodal predictor). If so, then that instruction may be selected for fast recovery.

If a single instruction can still not be identified by step 816, then a final tie-break step may be used. Whilst this step could arbitrarily select an instruction, in the example of FIG. 8 an age-based tie-break is used and at step 820 the oldest instruction from among the instructions identified in step 816 as the instructions having the instruction type and predictor source most likely to be mispredicted is selected for fast recovery.

Within the example of FIG. 8, the instruction types and prediction sources are not particularly limited, but when the instruction types include conditional, indirect, and return instructions, and the prediction sources include a TAGE predictor and bimodal predictor, then the selection process in FIG. 8 may for example select a single instruction according to the following ranking: low confidence>conditional (bimodal)>conditional (TAGE)>indirect>return>oldest.

Concepts described herein may be embodied in a system comprising at least one packaged chip. The apparatus described earlier is implemented in the at least one packaged chip (either being implemented in one specific chip of the system, or distributed over more than one packaged chip). The at least one packaged chip is assembled on a board with at least one system component. A chip-containing product may comprise the system assembled on a further board with at least one other product component. The system or the chip-containing product may be assembled into a housing or onto a structural support (such as a frame or blade).

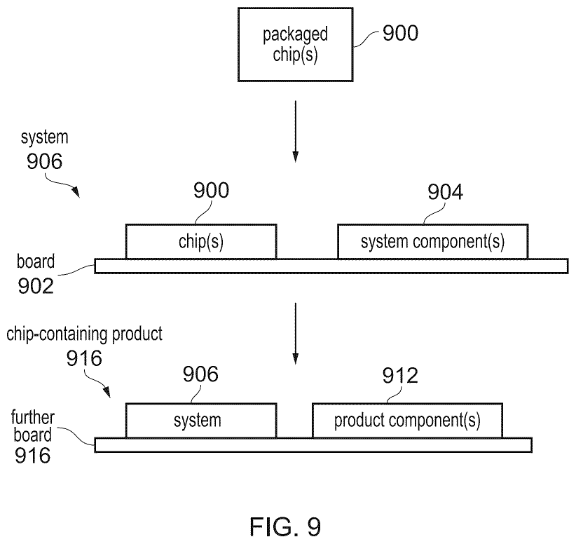

As shown in FIG. 9, one or more packaged chips 900, with the apparatus described above implemented on one chip or distributed over two or more of the chips, are manufactured by a semiconductor chip manufacturer. In some examples, the chip product 900 made by the semiconductor chip manufacturer may be provided as a semiconductor package which comprises a protective casing (e.g. made of metal, plastic, glass or ceramic) containing the semiconductor devices implementing the apparatus described above and connectors, such as lands, balls or pins, for connecting the semiconductor devices to an external environment. Where more than one chip 900 is provided, these could be provided as separate integrated circuits (provided as separate packages), or could be packaged by the semiconductor provider into a multi-chip semiconductor package (e.g. using an interposer, or by using three-dimensional integration to provide a multi-layer chip product comprising two or more vertically stacked integrated circuit layers).

In some examples, a collection of chiplets (i.e. modular chips which, when combined, provide the functionality of a chip) may itself be referred to as a chip. A chiplet may be packaged individually in a semiconductor package and/or together with other chiplets into a multi-chiplet semiconductor package (e.g. using an interposer, or by using three-dimensional integration to provide a multi-layer chiplet product comprising two or more vertically stacked integrated circuit layers).

The one or more packaged chips 900 are assembled on a board 902 together with at least one system component 904 to provide a system 906. For example, the board may comprise a printed circuit board. The board substrate may be made of any of a variety of materials, e.g. plastic, glass, ceramic, or a flexible substrate material such as paper, plastic or textile material. The at least one system component 904 comprise one or more external components which are not part of the one or more packaged chip(s) 900. For example, the at least one system component 904 could include, for example, any one or more of the following: another packaged chip (e.g. provided by a different manufacturer or produced on a different process node), an interface module, a resistor, a capacitor, an inductor, a transformer, a diode, a transistor and/or a sensor.

A chip-containing product 916 is manufactured comprising the system 906 (including the board 902, the one or more chips 900 and the at least one system component 904) and one or more product components 912. The product components 912 comprise one or more further components which are not part of the system 906. As a non-exhaustive list of examples, the one or more product components 912 could include a user input/output device such as a keypad, touch screen, microphone, loudspeaker, display screen, haptic device, etc. ; a wireless communication transmitter/receiver; a sensor; an actuator for actuating mechanical motion; a thermal control device; a further packaged chip; an interface module; a resistor; a capacitor; an inductor; a transformer; a diode; and/or a transistor. The system 906 and one or more product components 912 may be assembled on to a further board 914.

The board 902 or the further board 914 may be provided on or within a device housing or other structural support (e.g. a frame or blade) to provide a product which can be handled by a user and/or is intended for operational use by a person or company.

The system 906 or the chip-containing product 916 may be at least one of: an end-user product, a machine, a medical device, a computing or telecommunications infrastructure product, or an automation control system. For example, as a non-exhaustive list of examples, the chip-containing product could be any of the following: a telecommunications device, a mobile phone, a tablet, a laptop, a computer, a server (e.g. a rack server or blade server), an infrastructure device, networking equipment, a vehicle or other automotive product, industrial machinery, consumer device, smart card, credit card, smart glasses, avionics device, robotics device, camera, television, smart television, DVD players, set top box, wearable device, domestic appliance, smart meter, medical device, heating/lighting control device, sensor, and/or a control system for controlling public infrastructure equipment such as smart motorway or traffic lights.

Concepts described herein may be embodied in computer-readable code for fabrication of an apparatus that embodies the described concepts. For example, the computer-readable code can be used at one or more stages of a semiconductor design and fabrication process, including an electronic design automation (EDA) stage, to fabricate an integrated circuit comprising the apparatus embodying the concepts. The above computer-readable code may additionally or alternatively enable the definition, modelling, simulation, verification and/or testing of an apparatus embodying the concepts described herein.

For example, the computer-readable code for fabrication of an apparatus embodying the concepts described herein can be embodied in code defining a hardware description language (HDL) representation of the concepts. For example, the code may define a register-transfer-level (RTL) abstraction of one or more logic circuits for defining an apparatus embodying the concepts. The code may define a HDL representation of the one or more logic circuits embodying the apparatus in Verilog, SystemVerilog, Chisel, or VHDL (Very High-Speed Integrated Circuit Hardware Description Language) as well as intermediate representations such as FIRRTL. Computer-readable code may provide definitions embodying the concept using system-level modelling languages such as SystemC and SystemVerilog or other behavioural representations of the concepts that can be interpreted by a computer to enable simulation, functional and/or formal verification, and testing of the concepts.

Additionally or alternatively, the computer-readable code may define a low-level description of integrated circuit components that embody concepts described herein, such as one or more netlists or integrated circuit layout definitions, including representations such as GDSII. The one or more netlists or other computer-readable representation of integrated circuit components may be generated by applying one or more logic synthesis processes to an RTL representation to generate definitions for use in fabrication of an apparatus embodying the invention. Alternatively or additionally, the one or more logic synthesis processes can generate from the computer-readable code a bitstream to be loaded into a field programmable gate array (FPGA) to configure the FPGA to embody the described concepts. The FPGA may be deployed for the purposes of verification and test of the concepts prior to fabrication in an integrated circuit or the FPGA may be deployed in a product directly.

The computer-readable code may comprise a mix of code representations for fabrication of an apparatus, for example including a mix of one or more of an RTL representation, a netlist representation, or another computer-readable definition to be used in a semiconductor design and fabrication process to fabricate an apparatus embodying the invention. Alternatively or additionally, the concept may be defined in a combination of a computer-readable definition to be used in a semiconductor design and fabrication process to fabricate an apparatus and computer-readable code defining instructions which are to be executed by the defined apparatus once fabricated.

Such computer-readable code can be disposed in any known transitory computer-readable medium (such as wired or wireless transmission of code over a network) or non-transitory computer-readable medium such as semiconductor, magnetic disk, or optical disc. An integrated circuit fabricated using the computer-readable code may comprise components such as one or more of a central processing unit, graphics processing unit, neural processing unit, digital signal processor or other components that individually or collectively embody the concept.

### Some examples are set out in the following clauses:

1. An apparatus, comprising:
   prediction circuitry configured to generate a predicted outcome for each of a plurality of candidate control flow instructions and provide a confidence value associated with each predicted outcome;
   reduced-latency recovery circuitry configured to implement a reduced-latency recovery mechanism for a selected subset of the plurality of candidate control flow instructions, wherein implementing the reduced-latency recovery mechanism for a given control flow instruction comprises reducing a performance impact caused by a predicted outcome of the given control flow instruction being incorrect; and
   selection circuitry configured to perform a selection operation, comprising selecting the selected subset of the plurality of candidate control flow instructions, in dependence on the confidence values associated with the predicted outcomes for the plurality of candidate control flow instructions and at least one further attribute of the plurality of candidate control flow instructions.
2. The apparatus according to clause 1, wherein the selection circuitry is configured to select, based on the at least one further attribute, between two or more tied candidate control flow instructions for which the associated confidence values are the same.
3. The apparatus according to any preceding clause, wherein the at least one further attribute comprises an instruction encoding type.
4. The apparatus according to clause 3, wherein the selection circuitry is configured to perform the selection operation in dependence on a static ranking of instruction encoding types.
5. The apparatus according to clause 3, wherein the selection circuitry is configured to perform the selection operation in dependence on a dynamic ranking of instruction encoding types.
6. The apparatus according to any preceding clause, wherein the at least one further attribute comprises an indication of a prediction source selected to provide the predicted outcome for each of the plurality of candidate control flow instructions.
7. The apparatus according to any preceding clause, wherein the at least one further attribute comprises a relative position in program order of the plurality of candidate control flow instructions.
8. The apparatus according to any preceding clause, wherein the at least one further attribute comprises a memory address of a memory location associated with each of the plurality of candidate control flow instructions.
9. The apparatus according to clause 8, wherein the selection circuitry is configured to maintain a data structure identifying one or more penalised memory addresses, and the selection circuitry is configured to perform the selection operation in dependence on whether each of the plurality of candidate control flow instructions is associated with a penalised memory address.
10. The apparatus according to any preceding clause, wherein the plurality of candidate control flow instructions comprise control flow instructions selected to be issued in a given processing cycle.
11. The apparatus according to any preceding clause, wherein the prediction circuitry is configured to provide the confidence value having one of two states representing: a lower confidence predicted outcome and a higher confidence predicted outcome.
12. The apparatus according to clause 11, wherein the selection circuitry is configured to use the at least one further attribute to distinguish between tied candidate control flow instructions having the higher confidence predicted outcome.
13. The apparatus according to any preceding clause, comprising issuing circuitry responsive to a determination that the selected subset of candidate control flow instructions comprises a threshold number of control flow instructions to issue at least two of the selected subset of candidate control flow instructions in different processing cycles.
14. The apparatus according to any preceding clause, wherein implementing the reduced-latency recovery mechanism for the given control flow instruction comprises speculatively performing at least one recovery operation which would be performed if the predicted outcome of the given control flow instruction were determined to be incorrect.
15. The apparatus according to any preceding clause, comprising processing circuitry configured to perform data processing in response to instructions; wherein the processing circuitry is configured to trigger a pipeline flush in response to a determination that a predicted outcome of a target control flow instruction, for which the reduced-latency recovery mechanism is not implemented, is incorrect.
16. The apparatus according to any preceding clause, wherein the at least one further attribute comprises an indication of whether each of the plurality of candidate control flow instructions has been classified by the prediction circuitry as a hard-to-predict control flow instruction.
17. a System Comprising:
   the apparatus of any preceding clause, implemented in at least one packaged chip;
   at least one system component; and
   a board,
   wherein the at least one packaged chip and the at least one system component are assembled on the board.
18. A chip-containing product comprising the system of clause 17, wherein the system is assembled on a further board with at least one other product component.
19. A method, comprising:
   generating a predicted outcome for each of a plurality of candidate control flow instructions;
   providing a confidence value associated with each predicted outcome;
   implementing a reduced-latency recovery mechanism for a selected subset of the plurality of candidate control flow instructions, wherein implementing the reduced-latency recovery mechanism for a given control flow instruction comprises reducing a performance impact caused by a predicted outcome of the given control flow instruction being incorrect; and
   performing a selection operation, comprising selecting the selected subset of the plurality of candidate control flow instructions, in dependence on the confidence values associated with the predicted outcomes for the plurality of candidate control flow instructions and at least one further attribute of the plurality of candidate control flow instructions.
20. Computer-readable code for fabrication of an apparatus comprising:
   prediction circuitry configured to generate a predicted outcome for each of a plurality of candidate control flow instructions and provide a confidence value associated with each predicted outcome;
   reduced-latency recovery circuitry configured to implement a reduced-latency recovery mechanism for a selected subset of the plurality of candidate control flow instructions, wherein implementing the reduced-latency recovery mechanism for a given control flow instruction comprises reducing a performance impact caused by a predicted outcome of the given control flow instruction being incorrect; and
selection circuitry configured to perform a selection operation, comprising selecting the selected subset of the plurality of candidate control flow instructions, in dependence on the confidence values associated with the predicted outcomes for the plurality of candidate control flow instructions and at least one further attribute of the plurality of candidate control flow instructions.

In summary, an apparatus comprises prediction circuitry to generate a predicted outcome for each of a plurality of candidate control flow instructions and provide a confidence value associated with each predicted outcome. Reduced-latency recovery circuitry is provided to implement a reduced-latency recovery mechanism for a selected subset of candidate control flow instructions, reducing a performance impact caused by predicted outcomes of the selected subset of control flow instructions being incorrect. Selection circuitry is provided to select the selected subset of the plurality of candidate control flow instructions in dependence on the confidence values associated with the predicted outcomes for the plurality of candidate control flow instructions and at least one further attribute of the plurality of candidate control flow instructions.

In the present application, the words “configured to...” are used to mean that an element of an apparatus has a configuration able to carry out the defined operation. In this context, a “configuration” means an arrangement or manner of interconnection of hardware or software. For example, the apparatus may have dedicated hardware which provides the defined operation, or a processor or other processing device may be programmed to perform the function. “Configured to” does not imply that the apparatus element needs to be changed in any way in order to provide the defined operation.

In the present application, lists of features preceded with the phrase “at least one of” mean that any one or more of those features can be provided either individually or in combination. For example, “at least one of: A, B and C” encompasses any of the following options: A alone (without B or C), B alone (without A or C), C alone (without A or B), A and B in combination (without C), A and C in combination (without B), B and C in combination (without A), or A, B and C in combination.

Although illustrative embodiments of the invention have been described in detail herein with reference to the accompanying drawings, it is to be understood that the invention is not limited to those precise embodiments, and that various changes and modifications can be effected therein by one skilled in the art without departing from the scope of the invention as defined by the appended claims.

1. An apparatus, comprising:
prediction circuitry configured to generate a predicted outcome for each of a plurality of candidate control flow instructions and provide a confidence value associated with each predicted outcome;
reduced-latency recovery circuitry configured to implement a reduced-latency recovery mechanism for a selected subset of the plurality of candidate control flow instructions, wherein implementing the reduced-latency recovery mechanism for a given control flow instruction comprises reducing a performance impact caused by a predicted outcome of the given control flow instruction being incorrect; and
selection circuitry configured to perform a selection operation, comprising selecting the selected subset of the plurality of candidate control flow instructions, in dependence on the confidence values associated with the predicted outcomes for the plurality of candidate control flow instructions and at least one further attribute of the plurality of candidate control flow instructions.

2. The apparatus according to claim 1, wherein the selection circuitry is configured to select, based on the at least one further attribute, between two or more tied candidate control flow instructions for which the associated confidence values are the same.

3. The apparatus according to claim 1, wherein the at least one further attribute comprises an instruction encoding type.

4. The apparatus according to claim 3, wherein the selection circuitry is configured to perform the selection operation in dependence on a static ranking of instruction encoding types.

5. The apparatus according to claim 3, wherein the selection circuitry is configured to perform the selection operation in dependence on a dynamic ranking of instruction encoding types.

6. The apparatus according to claim 1, wherein the at least one further attribute comprises an indication of a prediction source selected to provide the predicted outcome for each of the plurality of candidate control flow instructions.

7. The apparatus according to claim 1, wherein the at least one further attribute comprises a relative position in program order of the plurality of candidate control flow instructions.

8. The apparatus according to claim 1, wherein the at least one further attribute comprises a memory address of a memory location associated with each of the plurality of candidate control flow instructions.

9. The apparatus according to claim 8, wherein the selection circuitry is configured to maintain a data structure identifying one or more penalised memory addresses, and
the selection circuitry is configured to perform the selection operation in dependence on whether each of the plurality of candidate control flow instructions is associated with a penalised memory address.

10. The apparatus according to claim 1, wherein the plurality of candidate control flow instructions comprise control flow instructions selected to be issued in a given processing cycle.

11. The apparatus according to claim 1, wherein the prediction circuitry is configured to provide the confidence value having one of two states representing: a lower confidence predicted outcome and a higher confidence predicted outcome.

12. The apparatus according to claim 11, wherein the selection circuitry is configured to use the at least one further attribute to distinguish between tied candidate control flow instructions having the higher confidence predicted outcome.

13. The apparatus according to claim 1, comprising issuing circuitry responsive to a determination that the selected subset of candidate control flow instructions comprises a threshold number of control flow instructions to issue at least two of the selected subset of candidate control flow instructions in different processing cycles.

14. The apparatus according to claim 1, wherein implementing the reduced-latency recovery mechanism for the given control flow instruction comprises speculatively performing at least one recovery operation which would be performed if the predicted outcome of the given control flow instruction were determined to be incorrect.

15. The apparatus according to claim 1, comprising processing circuitry configured to perform data processing in response to instructions;
wherein the processing circuitry is configured to trigger a pipeline flush in response to a determination that a predicted outcome of a target control flow instruction, for which the reduced-latency recovery mechanism is not implemented, is incorrect.

16. The apparatus according to claim 1, wherein the at least one further attribute comprises an indication of whether each of the plurality of candidate control flow instructions has been classified by the prediction circuitry as a hard-to-predict control flow instruction.

17. A system comprising:
the apparatus of claim 1, implemented in at least one packaged chip;
at least one system component; and
a board,
wherein the at least one packaged chip and the at least one system component are assembled on the board.

18. A chip-containing product comprising the system of claim 17, wherein the system is assembled on a further board with at least one other product component.

19. A method, comprising:
generating a predicted outcome for each of a plurality of candidate control flow instructions;
providing a confidence value associated with each predicted outcome;
implementing a reduced-latency recovery mechanism for a selected subset of the plurality of candidate control flow instructions, wherein implementing the reduced-latency recovery mechanism for a given control flow instruction comprises reducing a performance impact caused by a predicted outcome of the given control flow instruction being incorrect; and
performing a selection operation, comprising selecting the selected subset of the plurality of candidate control flow instructions, in dependence on the confidence values associated with the predicted outcomes for the plurality of candidate control flow instructions and at least one further attribute of the plurality of candidate control flow instructions.

20. A non-transitory computer-readable medium storing computer-readable code for fabrication of an apparatus comprising:
prediction circuitry configured to generate a predicted outcome for each of a plurality of candidate control flow instructions and provide a confidence value associated with each predicted outcome;
reduced-latency recovery circuitry configured to implement a reduced-latency recovery mechanism for a selected subset of the plurality of candidate control flow instructions, wherein implementing the reduced-latency recovery mechanism for a given control flow instruction comprises reducing a performance impact caused by a predicted outcome of the given control flow instruction being incorrect; and
selection circuitry configured to perform a selection operation, comprising selecting the selected subset of the plurality of candidate control flow instructions, in dependence on the confidence values associated with the predicted outcomes for the plurality of candidate control flow instructions and at least one further attribute of the plurality of candidate control flow instructions.
